(19) United States
(12) Patent Application Publication
(10) Pub. No.: US 2013/0132330 A1
(43) Pub. Date: May 23, 2013

(54) MANAGEMENT OF PRIVACY SETTINGS FOR A USER DEVICE

(71) Applicants: Joshua B. Hurwitz, Niles, IL (US); Guohua Hao, Vernon Hills, IL (US); Douglas A. Kuhlman, Inverness, IL (US)

(72) Inventors: Joshua B. Hurwitz, Niles, IL (US); Guohua Hao, Vernon Hills, IL (US); Douglas A. Kuhlman, Inverness, IL (US)

(73) Assignee: MOTOROLA MOBILITY, INC., Libertyville, IL (US)

(21) Appl. No.: 13/302,087

(22) Filed: Nov. 22, 2011

(51) Int. Cl. G06F 17/00

(52) U.S. Cl. 706/52

(57) ABSTRACT

A system and methods of managing privacy settings of a user are presented here. The system obtains context information that is indicative of a contextual scenario associated with operation of a user device and determines, with a first analytics system, a first set of privacy settings predictions that is influenced at least in part by the context information. A second analytics system is used to determine a second set of privacy settings predictions that is influenced at least in part by the context information. When the first set of privacy settings predictions differ from the second set of privacy settings predictions by at least a threshold amount, the system issues a query for user-specified privacy settings for the contextual scenario.

### TECHNICAL FIELD

Embodiments of the subject matter described herein relate generally to the management and handling of preference settings for users of electronic devices such as computer devices and mobile devices. More particularly, embodiments of the subject matter relate to a context-sensitive methodology for managing privacy settings for a user.

### BACKGROUND

Electronic devices such as computer systems, mobile telecommunication devices, and entertainment systems typically allow users to configure certain settings, features, and preferences that govern the manner in which the electronic devices function, handle data, communicate with other devices, and the like. For example, personal privacy settings allow a user to designate whether or not certain types of information can be collected, uploaded, or otherwise accessed by another system or device. In certain situations, a user may always allow data to be collected from his or her device. In other situations, the same user may prefer to limit or prohibit data collection. In other words, privacy settings may be context-sensitive and related to the specific operating scenario, use case, surrounding environment, etc.

Some electronic devices, such as mobile devices, may allow a user to designate different privacy settings to be applied to different operating scenarios. For example, a user might allow data collection during normal working hours, and otherwise prohibit data collection. As another example, a user might allow data analysis when the device is located in a commercial zone, and prohibit data analysis when the device is located in a residential zone. Although such general rules are helpful, there may be situations that represent exceptions to the general rules. For example, even though the device is located in a commercial zone, the user may prefer to keep his location confidential for any number of reasons.

Moreover, it may be difficult and time consuming for the user to enter privacy settings that contemplate a large number of different operating scenarios, situations, and contexts. Indeed, many users may incorrectly define their privacy settings if the procedure for entering the settings is too complicated. In some situations, a user may simply choose to ignore the customized privacy settings and merely rely on default settings.

Accordingly, it is desirable to have an improved technique for the management of privacy settings for a user device.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an exemplary embodiment of a system that manages privacy settings for a user;

FIG. 2 is a schematic representation of an exemplary embodiment of a server system suitable for use in the system shown in FIG. 1;

FIG. 3 is a flow chart that illustrates an exemplary embodiment of a process for configuring analytics systems that manage privacy settings; and

FIG. 4 is a flow chart that illustrates an exemplary embodiment of a process for managing privacy settings for a user.

### DETAILED DESCRIPTION

In accordance with an exemplary embodiment described here, a plurality of different analytics systems are utilized to detect when a user device is operating in a new contextual scenario that has not been contemplated before. The analytics systems generate privacy policy predictions (e.g., predictions or estimations of data privacy, communication privacy, and/or other privacy settings or preferences) applicable to the detected context. As used herein, a privacy policy can apply to one or more ways of handling, accessing, processing, storing, or treating data, user communications, or the like. For example, a privacy policy may be applicable to the collection, sharing, distributing, displaying, storing, securing, copying, deleting, management, and/or processing of user data. As another example, a privacy policy may relate to user communications and, therefore, influence what information can be shared with whom and under what circumstances. As yet another example, a privacy policy may be relate to the manner and/or extent to which use data or information is processed, handled, stored, or maintained.

The privacy policy predictions may be influenced by a number of factors, such as historical behavior and habits of the same user and/or collaborative filtering based on the behavior and habits of other users in a similar context. The methodology presented here determines when the results of the different analytics systems are in disagreement, which indicates that the user's actual privacy preferences for that particular scenario are difficult to accurately predict. If the results are not consistent, then the user is queried for his or her explicit instructions regarding privacy settings for that particular scenario at that particular time. This “instant notification” scheme is desirable to ensure that that user responds based on the current situation, and leads to better overall precision of the system. The methodology also encourages trust by enabling complete user control and by providing proper feedback at the right time in the right setting.

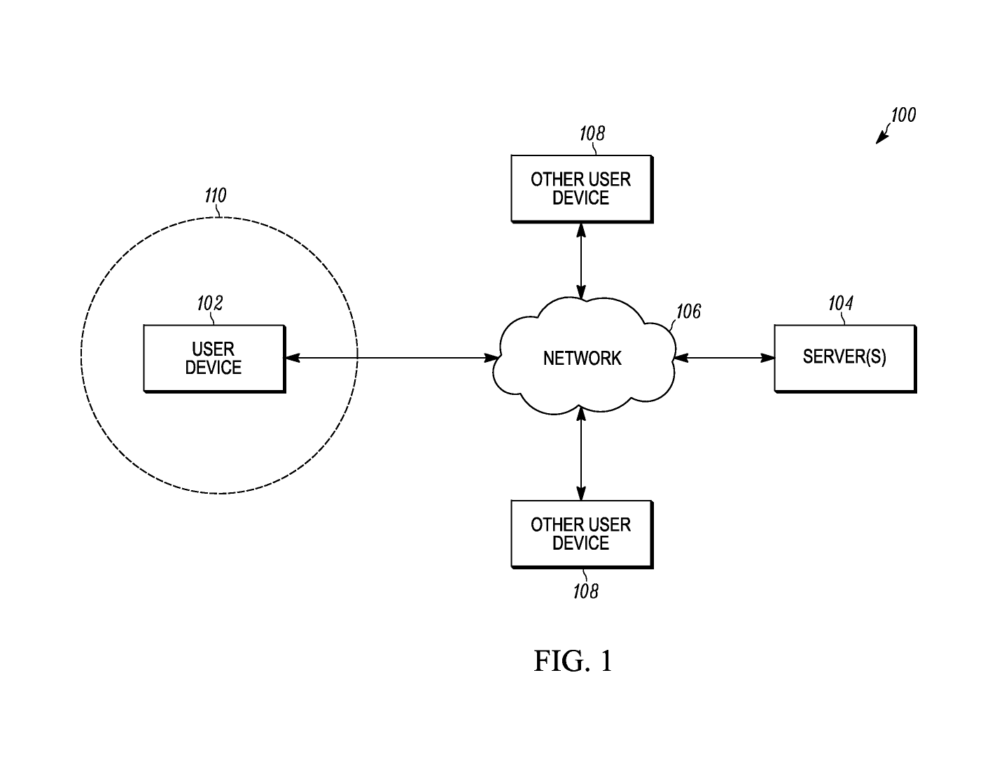

FIG. 1 is a schematic representation of an exemplary embodiment of a system 100 that manages privacy settings for a user of a user device 102. The system 100 is depicted in a simplified manner and having at least one server 104 that communicates with the user device 102 via a data communication network 106. The server 104 may also communicate and cooperate with any number of other user devices 108, using the data communication network 106. The user device 102 may be realized using any number of practical platforms, including, without limitation: a desktop, laptop, netbook, or tablet computer; a mobile telecommunication device; a personal digital assistant; a video services receiver (e.g., a set top box); a video game system; a digital media player; an electronic medical device; any web-enabled electronic device; or the like. Although not required, the following description assumes that the user device 102 is a portable device, such as a smartphone.

The data communication network 106 is any digital or other communications network capable of transmitting messages between the user devices 102, 108 and the server 104. In various embodiments, the data communication network 106 includes any number of public or private data connections, links or sub-networks supporting any number of communications protocols. In this regard, the data communication network 106 may include the Internet, for example, or any other network based upon TCP/IP or other conventional protocols. In various embodiments, the data communication network 106 also incorporates a wireless and/or wired telephone network, such as a cellular communications network for communicating with mobile phones, personal digital assistants, and/or the like. The data communication network 106 could also incorporate any sort of wireless or wired local area networks, such as one or more IEEE 802.3 and/or IEEE 802.11 networks.

The server 104 represents hardware, software, and processing logic that is designed to support at least the various privacy management and handling tasks described in more detail below. In practice, the server 104 could be realized using a single hardware system deployed at a remote location, or it could be realized in a distributed manner using multiple hardware components located across different physical locations. The server 104 is suitably configured to perform various processes related to the collection and processing of data from the user devices 102, 108. The specific configuration and operation of server systems are well known, and conventional aspects of the server 104 will not be described in detail here.

The specific data collected from (or maintained at) the user devices 102, 108 may differ from one embodiment to another, from one type of user device 102, 108 to another, and according to the current operating environment and scenario. Accordingly, data that might be available for collection at the user device 102 may include, without limitation: the current geographic position of the user device 102 (as obtained from a global positioning system receiver onboard the user device 102 or from cell-tower triangulation or nearby wireless network hotspots); the current date/time; the name or type of store, business, or establishment where the user device 102 is near or currently located; environmental sounds or noise samples (as measured or obtained by the user device 102); operating status data for the user device 102; the current temperature (as measured or obtained by the user device 102); geographic region data; zoning data; category, class, or genre data (which may be associated with media content being accessed by or played on the user device 102); data related to content viewing habits of the user; content recording data; web browsing data; photographic data; video data; wireless network status data; weather data; zip code data; area code data; social data or information such as contact lists or friend lists; applications installed and usage patterns; battery level data; wireless network signal strength data; general device usage data; and the like.

The server 104 collects or handles data from the user device 102 in accordance with certain user-specified preferences and settings that correspond to different contextual scenarios associated with operation or current status of the user device 102. For the exemplary embodiment presented here, privacy settings may be influenced by, guided by, or informed by a plurality of different analytics systems that independently assess the current contextual scenario of the user device 102 to predict whether or not data should be collected from the user device 102. For simplicity, the following description assumes that the analytics systems are resident at the server 104. In practice, however, one or more of the analytics systems could be implemented at the user device 102 and/or at another system or component other than the server 104.

In FIG. 1, the dashed circle schematically depicts the current operating environment, scenario, conditions, and geographic location of the user device (referred to herein as the current contextual scenario 110). The current contextual scenario 110 represents a given place, time, status, and context of operation for the user device 102. In practice, the current contextual scenario 110 may be indicated or determined by certain context information or status data that is associated with the operation of the user device 102. Some or all of the context information may be detected or obtained by the user device 102. In certain embodiments, some or all of the context information may be detected or obtained by one or more components or subsystems that communicate with or sense the user device 102. For example, some of the context information could be obtained by a system or application that monitors the presence of the user device 102, monitors data received by the user device 102, monitors data transmitted by the user device 102, or the like. Depending on the specific situation, some of the context information may be subjected to data collection by the server 104.

In certain embodiments, the context information represents status data that is received from the user device 102 and/or from a component or device that cooperates with the user device 102. In this regard, the status data may include, without limitation: geographic position data; time data; calendar data; schedule planning data; social data; environmental noise data; operating status data for the user device; temperature data; accelerometer data; navigation data; address book data; map data; geographic region data; zoning data; category, class, or genre data; content viewing habits data; content recording data; web browsing data; photographic data; audio data; video data; wireless network status data; near-field communication data; radio frequency identification (RFID) data; voice communications data; messaging data; weather data; zip code data; battery level data; and area code data. The specific type of context information listed above is not intended to be exhaustive. Indeed, the methodology described here need not rely on any one specific type of context information (over another type) or on any combination of different types of context information, although some context information will be provided as input.

The exemplary embodiment described here assumes that the analytics systems and the management of privacy settings are implemented at the server 104. Alternatively, some or all of the functionality of the server 104 could be resident at the user device 102. For example, the analytics functionality could be split between the server 104 and the user device 102. In this regard, one analytics system might be maintained at the server 104, and another analytics system might be maintained at the user device 102. It should be appreciated, therefore, that the scope of the described subject matter is intended to contemplate physical instantiations of the analytics systems at one or more servers, at the user device, and/or elsewhere within the particular embodiment of the system.

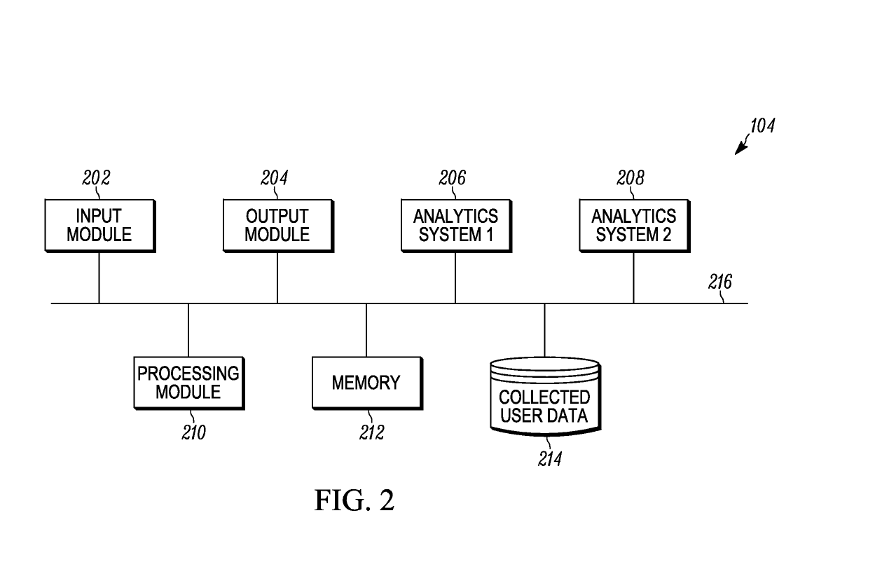

FIG. 2 is a schematic representation of an exemplary embodiment of the server 104. This simplified depiction of the server 104 includes, without limitation: an input module 202; an output module 204; a first analytics system 206; a second analytics system 208; a processing module 210; a suitable amount of memory 212; and storage for collected user data 214. These elements of the server 104 may be coupled together in an appropriate manner using any interconnection architecture 216 that can handle communication of data and instructions as needed to support the operation of the server 104. The server 104 can be realized using conventional computer hardware components, as is well understood. In this regard, the server 104 may be considered to be one exemplary embodiment of a computer-implemented system for managing privacy settings for the user device 102.

The input module 202 represents hardware, software, firmware, or the like that is configured to receive information and data from the user devices 102, 108 (see FIG. 1) and, if needed, other remote devices or systems (not shown). In certain implementations, the input module 202 is used to receive initial or baseline user-specified privacy settings or preference data that contemplates at least some anticipated operating scenarios. The baseline user-specified privacy settings may be received from the user device 102 or from another device that is available to the user of the user device 102. The input module 202 is also configured to receive context information that is indicative of a current contextual scenario associated with the operation of the user device 102. In addition, the input module 202 can be used to receive supplemental user-specified data collection instructions and/or supplemental user-specified privacy settings (e.g., from the user device 102) that may be necessary to resolve conflicts between the different analytics systems 206, 208.

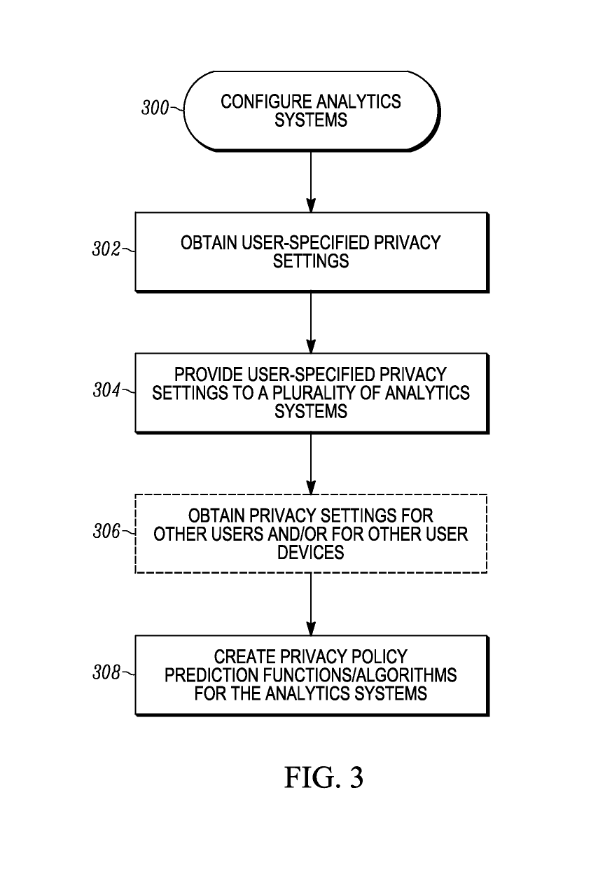

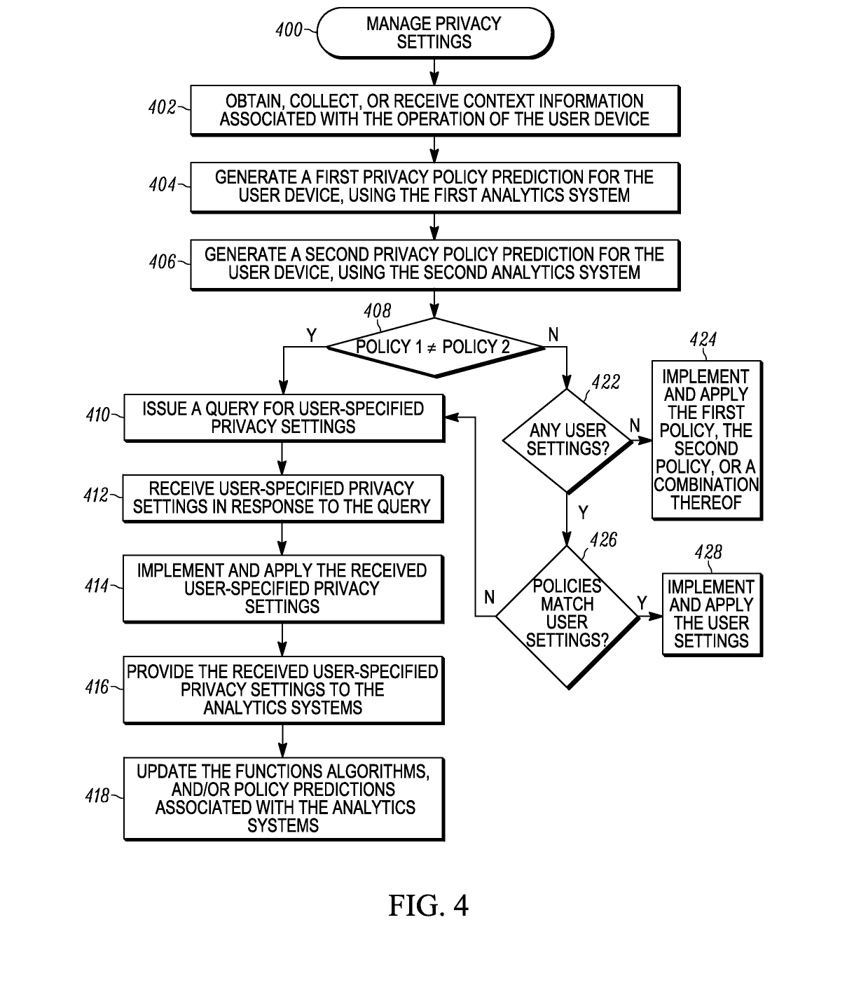

The output module 204 represents hardware, software, firmware, or the like that is configured to send information and data to the user devices 102, 108 and, if needed, other remote devices or systems (not shown). In certain embodiments, the output module 204 is configured to issue queries for user-specified instructions, additional user-specified privacy settings, and/or supplemental user preferences when needed. For example, the output module 204 queries the user device for user-specified privacy instructions corresponding to the current contextual scenario when the policy predictions generated by the two analytics systems are inconsistent. In an implementation that employs remotely supported analytics systems, the output module 204 can be used to communicate supplemental user-specified privacy settings to the remote analytics systems for purposes of updating the functions and algorithms used by the remote analytics systems (as explained in more detail below with reference to FIG. 3 and FIG. 4).

The system 100 described here utilizes at least two different analytics systems. In this regard, the two analytics systems are non-identical. As mentioned above, the analytics systems may be resident at one or more physical locations throughout the system 100, e.g., at the server 104, at the user device 102, and/or at another location remote to the user device 102. The exemplary embodiment of the server 104 shown in FIG. 2 represents the basic implementation that includes only two different analytics systems 206, 208. In practice, any number of additional analytics systems could be incorporated.

Each analytics system 206, 208 obtains and processes information and data that is associated with the current contextual operating scenario of the user device 102. Each analytics system 206, 208 processes its respective input data to determine (in accordance with a respective algorithm, function, or processing scheme) a corresponding privacy policy prediction that applies to the user device 102 when operating in the currently observed or detected contextual scenario. In other words, the analytics systems 206, 208 generate two different privacy policy predictions that specify privacy settings, rules, and/or preferences intended to govern the current operating situation. Each privacy policy prediction includes a recommendation, prediction, or estimation of whether or not the server 104 ought to collect data from the user device 102 under the current operating scenario. In practice, each privacy policy prediction may specify different privacy settings for each type, category, or class of data. For example, for the detected contextual scenario, a given privacy policy prediction might require the collection of global positioning system (GPS) data, require the collection of accelerometer data, and prohibit the collection of address data. In contrast, for a different contextual scenario, the same privacy policy prediction might call for the collection of as much user data as possible.

As described in more detail herein, each analytics system 206, 208 may be designed as a dynamic and updateable module such that their privacy prediction algorithms/functions can be revised and influenced by changing factors and parameters. For example, the analytics systems 206, 208 may be responsive to a set of initial or baseline user-specified privacy settings for the user device 102 and/or to a set of default privacy settings that have general applicability across all users. As another example, the analytics systems 206, 208 may be updated in response to ongoing user-specified privacy instructions that supplement or supersede the baseline user-specified privacy settings. As yet another example, the analytics systems 206, 208 may be updated in response to the privacy settings or preferences of users other than the user of the user device 102 (e.g., the users of the other user devices 108 shown in FIG. 1).

The analytics systems 206, 208 may be realized using fundamental and general techniques, methodologies, and/or processing engines that are available from suppliers and vendors. Accordingly, the manner in which the analytics systems 206, 208 generate their results will not be described in detail here. Thus, the basic functionality and feature set of each analytics system 206, 208 may be conventional in nature, but supplemented and modified as needed to support the system 100 described here. For example, the Google Prediction API and the RapidMiner data mining application are representative analytics systems that are similar to those described above for the analytics systems 206, 208. It should be appreciated that these published applications are merely exemplary, and that a wide variety of other engines, software, and applications could serve as the analytics systems 206, 208.

FIG. 3 is a flow chart that illustrates an exemplary embodiment of a process 300 for configuring the analytics systems 206, 208. The process 300 could be executed one or more times to initialize the analytics systems 206, 208 and/or to dynamically update the analytics systems 206, 208 in an ongoing manner. The various tasks performed in connection with the process 300 may be performed by software, hardware, firmware, or any combination thereof. For illustrative purposes, the following description of the process 300 may refer to elements mentioned above in connection with FIG. 1 and FIG. 2. In practice, portions of the process 300 may be performed by different elements of the described system, e.g., a user device, a server system, or a component within the operating environment of the user device. It should be appreciated that the process 300 may include any number of additional or alternative tasks, the tasks shown in FIG. 3 need not be performed in the illustrated order, and the process 300 may be incorporated into a more comprehensive procedure or process having additional functionality not described in detail herein. Moreover, one or more of the tasks shown in FIG. 3 could be omitted from an embodiment of the process 300 as long as the intended overall functionality remains intact.

The process 300 may begin by obtaining user-specified privacy settings for the user device (task 302). The user-specified privacy settings may be obtained from the user device itself and/or from a different device or system to which the user has access. These privacy settings could represent an initial privacy policy as specified by the user. It should be appreciated that the amount and extent of the initial privacy settings can vary from one embodiment to another, from user to user, and the like. For example, a given user may spend a significant amount of time entering a comprehensive set of baseline privacy settings, while another user may not want to be bothered with designating any user-specified privacy settings.

The process 300 continues by providing any user-specified privacy settings to at least one of a plurality of different analytics systems (task 304). For the exemplary embodiment shown in FIG. 2, the user-specified privacy settings are provided to both of the analytics systems 206, 208. The analytics systems can then be updated or configured with the user-specified privacy settings such that the privacy policy predictions generated by the analytics systems are responsive to or otherwise influenced by the user-specified privacy settings.

As an optional feature, the process 300 may also obtain privacy settings for additional user devices (other than the user device of interest) and/or privacy settings for different users (other than the user of interest), as indicated by the task 306 in FIG. 3. The analytics systems can then be updated or configured with the “third party” privacy settings such that the privacy policy predictions generated by the analytics systems are responsive to or otherwise influenced by the privacy preferences of other users. This enables the analytics systems to react to trends and tendencies associated with a population of users. For example, if a large percentage of users prefer to keep a certain type of data private whenever they are at home, then the analytics systems can adjust their privacy policy predictions for the user device of interest, for consistency with the preferred privacy settings of the sampled set of other users.

The exemplary embodiment of the process 300 continues by creating respective privacy policy prediction functions or algorithms for the different analytics systems (task 308). As mentioned previously, the privacy functions/algorithms are used to generate the different privacy policy estimates or predictions in response to the currently detected contextual scenario for the user device of interest. Again, each distinct analytics system has a different privacy prediction function associated therewith. This allows the system to leverage different predictive methodologies and approaches to better estimate the user's desired privacy settings for previously “unknown” contextual scenarios.

FIG. 4 is a flow chart that illustrates an exemplary embodiment of a process 400 for managing privacy settings for a user. The various tasks performed in connection with the process 400 may be performed by software, hardware, firmware, or any combination thereof. For illustrative purposes, the following description of the process 400 may refer to elements mentioned above in connection with FIGS. 1-3. In practice, portions of the process 400 may be performed by different elements of the described system, e.g., a user device, a server system, or a component within the operating environment of the user device. It should be appreciated that the process 400 may include any number of additional or alternative tasks, the tasks shown in FIG. 4 need not be performed in the illustrated order, and the process 400 may be incorporated into a more comprehensive procedure or process having additional functionality not described in detail herein. Moreover, one or more of the tasks shown in FIG. 4 could be omitted from an embodiment of the process 400 as long as the intended overall functionality remains intact.

The process 400 may begin by obtaining, collecting, or otherwise receiving context information that is indicative of a contextual scenario associated with the operation of the user device of interest (task 402). The context information is collected in real-time or substantially real-time such that it is indicative of a currently detected contextual scenario. In certain embodiments, at least some of the context information is realized as status data received from the user device. In this regard, the status data may be obtained from one or more sensors, devices, applications, or transducers onboard the user device, such as an accelerometer, a microphone, a web browser, a GPS receiver, a navigation application, a calendar or scheduling application, or a camera. In some embodiments, at least some of the context information is obtained from one or more sensors, devices, applications, or transducers that cooperate with the user device and/or that are in close proximity to the user device. For example, the context information could be obtained from a radio frequency identification reader, a wireless access device, a cellular service base station, or any component or system that communicates with the user device. Different types of context information were listed above with reference to FIG. 1 and FIG. 2.

In accordance with the illustrated embodiment of the process 400, the first analytics system generates a first privacy policy prediction for the user device (task 404), and the second analytics system generates a second privacy policy prediction for the user device (task 406). Notably, the generated privacy policy predictions are each influenced at least in part by the collected context information. As explained previously, the generated privacy policy predictions may also be influenced by baseline user-specified privacy settings and/or privacy preferences of other system users. In connection with the generation of the privacy policy predictions, the analytics systems determine respective sets of privacy settings, preferences, and/or guidelines for the currently detected contextual scenario, as indicated by the context information. Accordingly, a first set of predicted privacy settings (generated by the first analytics system) specifies whether or not data is collected from the user device, based on a first determination scheme, function, or algorithm, and a second set of predicted privacy settings (generated by the second analytics system) specifies whether or not data is collected from the user device, based on a second determination scheme, function, or algorithm. In certain embodiments, at least one of the privacy policy predictions (one or more, or all) is provided to the user device as a recommended privacy policy. This may be helpful as guidance for the user to decide how best to designate his or her actual privacy settings if needed.

The process 400 continues by comparing the different privacy policy predictions (query task 408) to determine whether or not they are consistent with one another. If the predicted policies are inconsistent by at least a threshold amount, then the process 400 follows the “Yes” branch of query task 408. Otherwise, the process 400 follows the “No” branch of query task 408 as described below.

In reality, the different privacy policy predictions will not provide identical results for every possible scenario. Moreover, the different privacy policy predictions may be virtually identical, substantially consistent, or differ by a significant amount. In other words, the amount of consistency may fall anywhere between the range of no consistency and complete consistency. Accordingly, the consistency threshold used during query task 408 can be selected to satisfy the desired goals of the system. The complexity of the consistency check will vary depending upon the complexity of the privacy policies, the number of different privacy settings, and possibly other practical factors. As a simple example, assume that the privacy policy predictions only designate one of two options: “collect all possible data” and “collect no data”. For this simple example, the two predicted policies are either consistent or inconsistent, with no middle ground. In contrast, if the privacy policy predictions designate different privacy settings for particular types of data, limits on the amount of data that can be collected in different situations, and other complicated relationships between data collection settings and the different types of context information, then the process 400 may need to contemplate a sliding scale of consistency for the determination made at query task 408. It should be appreciated that various consistency measures between multiple analytics systems 206, 208 are known and, therefore, could be leveraged in the system described here.

If query task 408 determines that the predicted privacy policies are inconsistent by at least the threshold amount, then the process 400 issues a query for user-specified privacy settings to be used for the currently detected contextual scenario (task 410). For the particular embodiment depicted in FIG. 1, the query is issued from the server 104, and the query is directed to the user device 102. Alternatively, the query could be issued as an internal notification by the user device 102. As another option, the query could be issued from the server 104 and directed to a device or a system other than the user device 102, as long as the user of the user device 102 can receive and respond to the query.

This example assumes that the user responds to the query by providing additional user-specified privacy settings that serve to supplement any previously entered user-specified settings. Accordingly, the process 400 receives the additional user-specified privacy settings from the user device in response to issuing the query (task 412), and implements and applies the received user-specified privacy settings as needed (task 414). In practice, the received user-specified privacy settings represent specific instructions related to privacy and the user's desired privacy preferences for the current contextual scenario. To this end, the server will either allow or prohibit data collection from the user device, in accordance with the received user-specified instructions.

The exemplary embodiment of the process 400 also provides the supplemental user-specified privacy settings to the first analytics system and/or the second analytics system (task 416) for use as adaptive feedback. In this regard, the process 400 can update the prediction functions, algorithms, and/or policies associated with either or both of the analytics systems (task 418). In other words, the predicted set of privacy settings used by the first analytics system and/or the predicted set of privacy settings used by the second analytics system can be updated to reflect the newly received user-specified privacy settings. Going forward, therefore, the analytics systems will be influenced by the supplemental user-specified privacy settings, and will consider the current contextual scenario as a “known” situation and the analytics systems will respond in accordance with the user's particular instructions.

Referring again to query task 408, if the privacy policy predictions are not inconsistent with one another (i.e., the predicted policies are in agreement or “match” one another), then the process 400 continues by checking whether or not there are any applicable user-specified privacy settings to govern the current scenario (query task 422). If there are no applicable user-specified privacy settings for the detected scenario, then the process 400 can proceed to implement and apply the first predicted privacy policy, the second predicted privacy policy, or a combination thereof (task 424). Implementing at least one of the different privacy policy predictions in this manner can be performed automatically in lieu of prompting the user.

If, however, applicable user-specified privacy settings are found (the “Yes” branch of query task 422), then the process 400 can compare the predicted privacy policies against the user-specified settings corresponding to the detected operating scenario (query task 426). If the predicted policies are consistent with, match, or are otherwise in agreement with the user-specified privacy settings, then the process 400 implements and applies the user-specified settings (task 428). Alternatively, the process 400 could implement and apply either or both of the predicted policies.

If query task 426 determines that the predicted privacy policies are inconsistent with the user-specified privacy settings, then the process 400 continues as described above (see task 410) in an attempt to acquire user-specified privacy settings to govern the current scenario. This serves as a double check to ensure that the user has designated appropriate settings. As mentioned above, the process 400 could provide the outputs of the analytics systems (e.g., the predicted privacy settings) to the user at this time as a recommendation. Thus, the user can consider the recommendation before designating his or her specific privacy preferences to be used for the current situation.

It should be appreciated that the process 400 may be performed in an ongoing manner, or in parallel instantiations if so desired. Thus, task 402 may be re-entered following the completion of task 410 and/or the completion of task 420.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

For the sake of brevity, conventional techniques related to data transmission, sensor systems, analytics algorithms, data collection and analysis, and other functional aspects of the systems (and the individual operating components of the systems) may not be described in detail herein.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of managing privacy settings of a user, the method comprising:
obtaining context information that is indicative of a contextual scenario associated with operation of a user device;
determining, with a first analytics system, a first set of privacy settings predictions, the first set of privacy settings predictions being influenced at least in part by the context information;
determining, with a second analytics system, a second set of privacy settings predictions, the second set of privacy settings predictions being influenced at least in part by the context information; and
when the first set of privacy settings predictions differ from the second set of privacy settings predictions by at least a threshold amount, issuing a query for user-specified privacy settings for the contextual scenario.

2. The method of claim 1, further comprising:
receiving the user-specified privacy settings; and
implementing the user-specified privacy settings for the contextual scenario.

3. The method of claim 2, further comprising providing the user-specified privacy settings to the first analytics system to update the first set of privacy settings predictions.

4. The method of claim 2, further comprising:
updating the first set of privacy settings predictions in a manner that is influenced by the user-specified privacy settings; and
updating the second set of privacy settings predictions in a manner that is influenced by the user-specified privacy settings.

5. The method of claim 1, wherein:
the first set of privacy settings predictions determines whether or not data is collected from the user device, based on a first determination scheme; and
the second set of privacy settings predictions determines whether or not data is collected from the user device, based on a second determination scheme that is different than the first determination scheme.

6. The method of claim 1, further comprising receiving the user-specified privacy settings from the user device, wherein receiving the user-specified privacy settings is performed in response to issuing the query.

7. The method of claim 1, wherein obtaining the context information comprises receiving status data from the user device.

8. The method of claim 7, wherein the status data comprises data selected from the group consisting of: geographic position data; time data; calendar data; schedule planning data; social data; environmental noise data; operating status data for the user device; temperature data; accelerometer data; navigation data; address book data; map data; geographic region data; zoning data; category, class, or genre data; content viewing habits data; content recording data; web browsing data; photographic data; audio data; video data; wireless network status data; near-field communication data; radio frequency identification (RFID) data; voice communications data; messaging data; weather data; zip code data; battery level data; and area code data.

9. The method of claim 1, further comprising implementing the first set of privacy settings predictions, the second set of privacy settings predictions, or a combination of the first set of privacy settings predictions and the second set of privacy settings predictions, when the first set of privacy settings predictions are consistent with the second set of privacy settings predictions and no user-specified privacy settings apply to the contextual scenario.

10. A method for managing privacy settings for a user device, the method comprising:
obtaining user-specified privacy settings for the user device;
providing the user-specified privacy settings to at least one of a plurality of different analytics systems, wherein each of the plurality of different analytics systems is configured to generate privacy policy predictions in response to different contextual scenarios associated with operation of the user device and in response to the user-specified privacy settings;
collecting context information that is indicative of a currently detected contextual scenario associated with operation of the user device;
generating, with the plurality of different analytics systems, a plurality of different privacy policy predictions for the user device, each of the plurality of different privacy policy predictions being influenced at least in part by the collected context information; and
when the plurality of different privacy policy predictions are inconsistent by at least a threshold amount, issuing a query for supplemental user-specified privacy settings for the currently detected contextual scenario.

11. The method of claim 10, further comprising updating at least one of the plurality of different analytics systems with the supplemental user-specified privacy settings.

12. The method of claim 10, further comprising receiving the supplemental user-specified privacy settings from the user device.

13. The method of claim 12, further comprising implementing the supplemental user-specified privacy settings to either allow or prohibit data collection from the user device.

14. The method of claim 10, wherein at least one of the plurality of different privacy policy predictions is influenced by privacy settings for additional user devices other than the user device.

15. The method of claim 10, wherein collecting the context information comprises receiving status data from the user device.

16. The method of claim 10, further comprising providing at least one of the plurality of different privacy policy predictions to the user device as a recommended privacy policy.

17. The method of claim 10, further comprising implementing at least one of the plurality of different privacy policy predictions, in lieu of the user-specified privacy settings, when the plurality of different privacy policy predictions are consistent with one another and no user-specified privacy settings apply to the currently detected contextual scenario.

18. A computer-implemented system for managing privacy settings for a user device, the system comprising:
an input module configured to receive context information that is indicative of a contextual scenario associated with operation of the user device;
a first analytics system configured to determine, in accordance with a first function, a first privacy policy prediction for the user device operating in the contextual scenario;
a second analytics system configured to determine, in accordance with a second function that is different than the first function, a second privacy policy prediction for the user device operating in the contextual scenario; and
an output module configured to issue a query for user-specified data collection instructions corresponding to the user device operating in the contextual scenario, wherein the output module issues the query when the first privacy policy prediction is inconsistent with the second privacy policy prediction.

19. The system of claim 18, wherein the input module is configured to receive the user-specified data collection instructions from the user device.

20. The system of claim 19, wherein the first function and the second function are updated in response to receiving the user-specified data collection instructions.
